(19) United States
(12) Patent Application Publication
(10) Pub. No.: US 2008/0063105 A1
(43) Pub. Date: Mar. 13, 2008

(54) SYSTEM AND METHOD FOR IMPLEMENTING PREAMBLE CHANNEL IN WIRELESS COMMUNICATION SYSTEM

(75) Inventors: Jian Gu, Beijing (CN); Hongkui Yang, San Diego, CA (US); Linlin He, Beijing (CN); Pengcheng Su, Beijing (CN)

Correspondence Address: BAKER & MCKENZIE LLP;PATENT DEPARTMENT, 2001 ROSS AVENUE, SUITE 2300, DALLAS, TX, 75201, US

(73) Assignee: VIA TELECOM, INC., San Diego, CA (US)

(21) Appl. No.: 11/844,209

(22) Filed: Aug. 23, 2007

Related U.S. Application Data
(60) Provisional application No. 60/825,527, filed on Sep. 13, 2006.

(51) Int. Cl. H04L 27/28; H04L 23/02; H04L 5/12

(52) U.S. Cl. 375/265; 375/260

(57) ABSTRACT

A preamble channel encoder, e.g., in a UHDR-DO system, uses a channel structure that can efficiently transmit more information bits, yet achieve sufficient detection and false alarm performance. The preamble channel encoder uses tail-biting convolutional coding and Cyclical Redundancy Check (CRC). The preamble channel structure can be used to encode, e.g., rate indicator bits, while a MAC identifier encoder, e.g., a Reed-Solomon encoder, is used to encode MAC identifier bits. The encoded rate indictor and MAC identifier bits can then be mapped to the appropriate tones in an OFDM encoding scheme.

### CROSS REFERENCE TO RELATED APPLICATIONS INFORMATION

This application claims priority under 35 U.S.C. 119(e) to U.S. Provisional Patent Application Ser. No. 60/825,527, entitled “Coding For Preamble In UHDR-DO,” filed on Sep. 13, 2006, which is incorporated herein in its entirety as if set forth in full.

### BACKGROUND INFORMATION

1. Field

The embodiments described herein are related to wireless communication and more particular to implementation of a preamble channel that provides information related to how to receive a traffic channel in a wireless communication system.

2. Background

It will be understood that in a wireless communication system certain traffic channels are used to communicate data, e.g., between a base station or wireless access point and a wireless communication device. It will also be understood that certain information is required in order for a wireless communication device to accurately receive and decode the traffic channel. For example, in a Code Division Multiple Access (CDMA) system, voice and data traffic can be carried in message frames of various lengths. A wireless communication device may need to decode a plurality of message frames in order determine the complete payload of information. Preambles are attached to the message frames to convey information as to the number of frames that will carry the payload. In addition to the number of frames, preambles can also carry information identifying the MAC (Media Access Control) ID and the transmit format of data. The transmit format may include the target destinations, the transmission rates of the message frames, the number of total packets, the packet size, the modulation, HARQ (Hybrid Automatic Repeat Request) transmission times coding rate, and MIMO (Multiple-Input Multiple Output) rank. Other information can also be included in the preambles, e.g., the radio link protocol (RLP) sequence numbers of the message frames.

It is important to accurately decode the preambles since the information contained therein is needed to accurately decode the actual payload. Accordingly, more recent systems have implemented methods to help ensure accurate decoding of the preamble information. For example, in certain systems, such as a cdma2000 Evolution Data Optimized (EV-DO) system, the preamble information is actually encoded on a preamble channel that is transmitted with, or before the traffic channel. Such a preamble channel can include information such as a medium access control identifier, a subpacket identifier, rate indicator for information, an ARQ channel identifier, a HARQ transmission times coding rate, a MIMO rank, the number of packets, the packet size, and the modulation. The MAC identifier is assigned to a wireless communication device in accordance with a unique International Mobile Station Identify (IMSI) when the wireless communication device enters a particular communication system. Additional information, such as the number of slots used per data traffic channel, can also be carried by the preamble channel, e.g., for use in multi-channel systems.

The term “wireless communication device” as used in this description and the claims that follow is intended to refer to any device capable of wireless communication with, e.g., a base station or wireless access point. Thus, the term “wireless communication device” includes, but is not limited to, cellular telephone type devices, also known as handsets, mobiles, mobile handsets, mobile communication devices, etc., Personal Digital Assistants (PDAs) with wireless communication capability, smartphones, computing devices with wireless communication capability including handheld computers, laptops, or even desktop computers, etc.

It will also be understood that while many of the examples and embodiments provided herein refer to Wireless Wide Area Networks (WWANs), the systems and methods described herein can also be applied to Wireless Personal Area Networks (WPANs), Wireless Local Area Networks (WLANs), Wireless Metropolitan Area Networks (WMANs), etc. It will also be understood that such networks include some type of access device or infrastructure such as a base station, e.g., in a WWAN or WMAN, or an access point, e.g., in a WLAN. It will be understood therefore that reference to these access devices/infrastructures are interchangeable and that reference to one should not exclude reference to another unless explicitly stated or where such is dictated by the context of the reference.

Accordingly, e.g., an EV-DO system includes a preamble channel as described above; however, the EV-DO family of standards has undergone an evolution from the original standard, referred to as 1xEV-DO, to a Rev. A, Rev. B, and now a Rev. C., which provides much higher data rates. Rev. C can have multiple operational modes at least one of which can be backwards compatible with EV-DO and is referred to as Ultra High Data Rate (UHDR)-DO. In order for a UDHR-DO system to be backward compatible with an EV-DO system, the preamble channel, which is not necessarily part of Rev. C, must be implemented.

EV-DO Rev. C uses a modulation technique known as Orthogonal Frequency Division Modulation (OFDM), which can be thought of as both a modulation and a multiple access technique that segments a communication channel in such a way that many users can share the channel. Like Frequency Division Multiplexing (FDM), OFDM segments the channel frequency by dividing the channel spectrum into a certain number of equally spaced sub-carriers, or tones. A segment of the payload directed to a specific user can then be carried by each tone or a subset of tones. Unlike FDM, however, the tones in OFDM are orthogonal and can therefore overlap slightly

FIG. 4 is a diagram illustrating overlapping tones 402 of an OFDM scheme. As can be seen the overall spectrum (B) has been divided into a certain number of tones 402. It will be understood that in an FDM system, guard bands are required between the frequency channels so that they do not interfere with each other. In the OFDM scheme of FIG. 4, however, it can be seen that the tones 402 can overlap each other. This is because the tones 402 are orthogonal and therefore do not interfere with each other. More of the overall bandwidth of spectrum (B) can be used due to the orthogonal nature of the tones 402.

An OFDM system will often take a serial data stream and split it into N-parallel data streams, each with a data rate of 1/N of the data rate of the serial data stream. Each stream is then mapped to a tone and combined together using the inverse Fast Fourier Transform (FFT) to yield a time-domain waveform to be transmitted.

An OFDM system can also be thought of as a multiple access technique, because an individual tone or group of tones can be assigned to different users. Users can be assigned a fixed number of tones when they have information to send or receive, or a user can be assigned a variable amount of tones based, e.g., on how much information the user is to send or receive. The assignments can be controlled by the MAC layer, which schedules resources based on user demand.

FIG. 5 is a two dimensional diagram of the channel resources in an OFDM system. As can be seen, the channel resources can be divided in frequency, i.e., divided into tones, and time slots. Thus, the channel resources can look like a set of tiles. The individual tiles can then be assigned to various users or channels. For example, the preamble channel can be assigned to certain tiles, while a traffic channel 1 can be assigned to another set of tiles, and a traffic channel 2 is assigned to still another set of tiles, etc.

### SUMMARY

Systems and methods for implementing a preamble channel, e.g., in a UHDR-DO system, are presented below. The channel structure used to implement the preamble channel can efficiently transmit more information bits, yet achieve sufficient detection and false alarm performance uses tail-biting convolutional coding and Cyclical Redundancy Check (CRC). The preamble channel structure can be used to encode, e.g., rate indicator bits, while a MAC identifier encoder, e.g., a Reed-Solomon encoder, is used to encode MAC identifier bits. The encoded rate indictor and MAC identifier bits can then be mapped to the appropriate tones in an OFDM encoding scheme.

In one aspect, a transmitter design is presented that embodies the above encoding techniques. Such a transmitter design can be incorporated into uplink or downlink transmitter designs as required. The transmitter of a preamble channel comprises an encoder, a modulation block, a medium access control (MAC) identifier encoder, and a tone mapping block. The encoder, configured to encode information bits onto the preamble channel, comprises a cyclical redundancy check (CRC) encoding block, a tail-biting convolutional encoder coupled with the CRC encoding block, and an interleaving block coupled with the tail-biting convolutional encoder. The CRC encoding block is configured to receive the information bits, generate CRC bits, and add the CRC bits to the information bits forming input symbols. The tail-biting convolutional encoder is configured to generate output symbols from the input symbols using a tail biting technique. The interleaving block is configured to interleave the output symbols. The modulation block is configured to modulate the interleaved output symbols and generate modulated output symbols. The MAC identifier encoder is configured to encode MAC identifier data. The tone mapping block is configured to map the modulated output symbols and the encoded MAC identifier data onto tones assigned to the preamble channel.

In another aspect, a method for encoding a preamble channel signal is presented that embodies the various techniques described above and below. The method for encoding information bits onto a preamble channel comprises the following steps: generating CRC bits from the information bits; adding the CRC bits to the information bits forming input symbols; generating output symbols from the input symbols using a tail biting convolutional technique; interleaving the output symbols; modulating the interleaved output symbols; encoding MAC identifier bits; and mapping the modulated output symbols and encoded MAC identifier bits onto OFDM tones assigned to the preamble channel.

In another aspect, an access point is presented that embodies the various techniques describes above and below. The access point comprises a receiver for receiving coded signals and the OFDM transmitter for generating coded signals of a preamble channel.

In another aspect, an encoder for encoding information bits that embodies the various techniques describes above and below. The encoder comprises a repetition block, a CRC encoding block, a tail-biting convolutional encoder, and an interleaving block. The repetition block is configured to repeat the information bits. The CRC encoding block configured to receive the repeated information bits, generate CRC bits, and add the CRC bits to the information bits forming input symbols. The tail-biting convolutional encoder configured to generate output symbols from the input symbols using a tail biting technique. And the interleaving block coupled with the tail-biting convolutional encoder, interleaving block configured to interleave the output symbols.

These and other features, aspects, and embodiments of the invention are described below in the section entitled “Detailed Description.”

### BRIEF DESCRIPTION OF THE DRAWINGS

Features, aspects, and embodiments of the inventions are described in conjunction with the attached drawings, in which:

FIG. 1 is a diagram illustrating an example preamble channel encoder configured to encode the rate indicator bits for a preamble channel in accordance with one embodiment;

FIG. 2 is a diagram illustrating an example CRC generation circuit that can be included in the encoder of FIG. 1 in accordance with another embodiment;

FIG. 3 is a diagram illustrating an example transmitter that can include the preamble encoder of FIG. 1 in accordance with still another embodiment;

FIG. 4 is a diagram illustrating example tones in an OFDM system; and

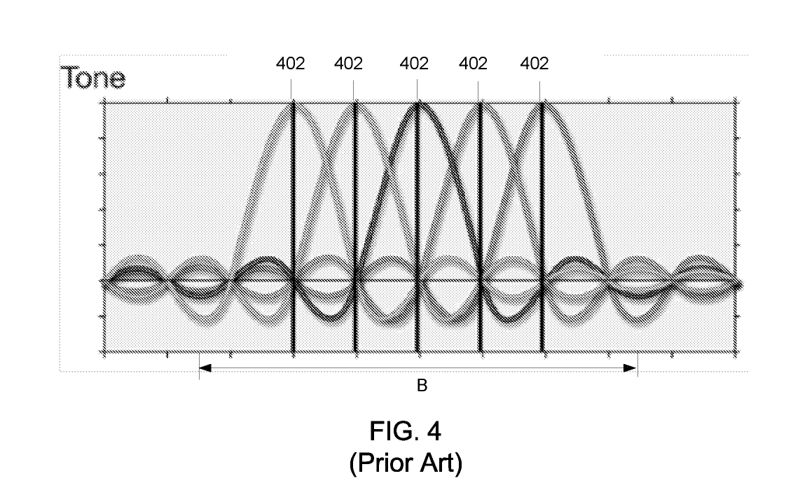

FIG. 5 is a diagram illustrating example channel resources in an OFDM system; and

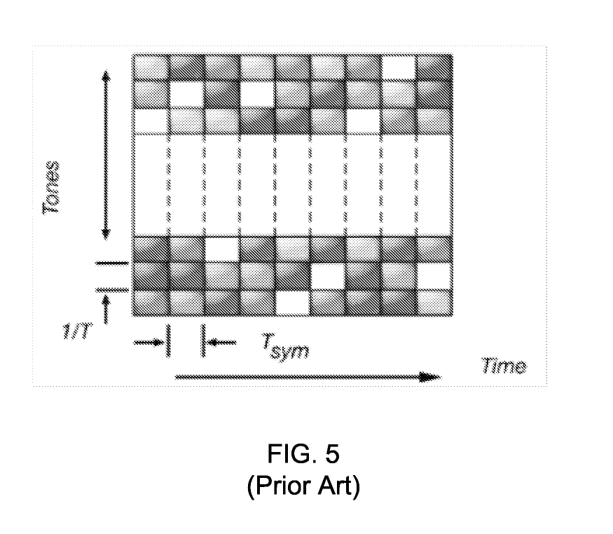

FIG. 6 is a flow chart illustrating an example method for encoding a data control channel in accordance with one embodiment.

### DETAILED DESCRIPTION OF THE PREFERRED EMBODIMENTS

The embodiments described below provide for preamble channel encoding that can efficiently transmit preamble information bits. The embodiments use tail-biting convolutional coding and CRC (Cyclic Redundancy Check) coupled with modulation schemes such as BPSK (Binary Phase Shift Keying), QPSK (Quadrate Phase Shift Keying) or QAM (Quadrate Amplitude Modulation). The embodiments described below are generally described in terms of BPSK; however, it will be understood that this does not exclude the use of other modulation techniques and is simply done for convenience.

Further, after tail-biting convolutional encoding and modulation, the modulated symbols can be further transformed according to the air interface standard being implemented, e.g., CDMA or OFDM, for transmission. For example, the signal can be transformed into an OFDM subcarrier waveform, e.g., with or without multiple antennas MIMO or beam-forming.

Implementation of the embodiments described below result in a frame structure with reduced overhead symbols, which allows for increased capability and a more efficient design. Further, such a frame structure requires lower transmission power or a lower signal to noise (Eb/N0) ratio in the receiver to achieve similar false alarm and missing detection performance as conventional solutions. Additionally, in some embodiments, it is unnecessary to make any tradeoff between false alarm and missing detection probabilities, because the CRC bit, as well as the information bits in certain implementations, including user information, transmission format information, and/or subcarrier or channelization code, etc., can be used to check errors. In some embodiments, the factors influencing whether the tradeoff between false alarm rates and whether mission detection probabilities exist include the number of CRC bits and the required false alarm rate. If the number of CRC bits is too few to provide a low false alarm rate, the tradeoff still exists.

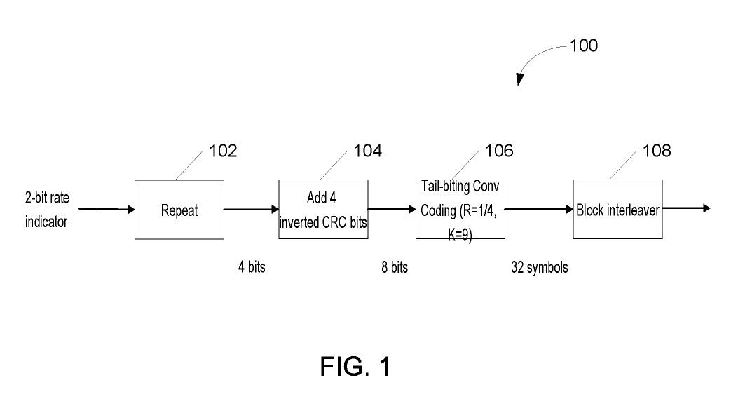

FIG. 1 is a diagram illustrating an example preamble channel encoder 100 configured in accordance with one embodiment of the systems and methods described herein. The encoder of FIG. 1 can be included, for example, in a forward link or reverse link transmitter in a UHDR-DO system. Specifically, encoder 100 can be used on the forward link to transmit preamble information to wireless communication devices. It will be understood that the encoder of FIG. 1, as with all embodiments described herein, can be implemented in software, hardware, or some combination thereof.

Thus, the encoder 100 of FIG. 1 can be used to encode the rate indication information, often 2-bits. As can be seen, encoder 100 comprises a repetition block 102 configured to receive the, e.g., 2-bit rate indictor and repeat it a certain number of times to generate a certain number of bits (b). CRC block 104 is configured to then add CRC bits (c) to the sequence of input data bits (b). In the example of FIG. 1, a 2-bit rate indicator is repeated once to generate a 4-bit data stream. Four inverted CRC bits (c) are added to the input bits (b) to form an 8-bit symbol that is then input to tail biting convolutional encoder 106. In certain implementations, the use of inverted CRC bits (c) can provide a slight performance improvement; however, it will be understood that in other embodiments, non-inverted CRC bits (c) can be added in CRC block 104. CRC bits can be used for alarm or missing detection probability determination in the receiver. An example implementation of CRC block 104 is described in more detail below.

The output of CRC block 104 will then comprise (b+c) bits and will be input to tail biting convolutional encoder 106. As will be understood, a convolutional encoder converts (k) input bits, in this case k=b+c, into a sequence of (n) bits. The n-bit sequence, or symbol, can then used to determine the k bits in the receiver. Thus, the effective rate (R) of encoder 102 is R=k/n.

It will be understood that in a conventional convolutional encoder 106, a tail sequence must be added to the end of the generated sequence in order to properly end the encoding process. The tail sequence is typically a series of “0's,” which add to the overhead associated with the data control channel. Tail biting means that the encoder starts in the state given by the (m) last bits of the information sequence, where m is the size of the memory, or length of the register included in the encoder. Hence, the encoder starts and ends in the same state and thus the loss in rate of the code associated with conventional convolutional encoders is eliminated. In other words, the need for the tail sequence can be eliminated, which reduces overhead.

The output of tail biting convolutional encoder 106 is then input to block interleaver 108. Interleaving is a way to arrange data in a non-contiguous way in order to increase performance. Interleaving is mainly used in digital data transmission technology to protect the transmission against burst errors. These errors overwrite a lot of bits in a row, but seldom occur. Interleaving is used to solve this problem. All data is transmitted with some control bits (independently from the interleaving), such as error correction bits that enable the channel decoder to correct a certain number of altered bits. If a burst error occurs, and more than this number of bits is altered, the codeword cannot be correctly decoded. So the bits of a number of codewords, or symbols are interleaved and then transmitted. This way, a burst error affects only a correctable number of bits in each codeword, so the decoder can decode the codewords correctly.

The output of block interleaver 108 can then be modulated, e.g., using BPSK, and then mapped to certain OFDM tones for transmission as described in more detail below.

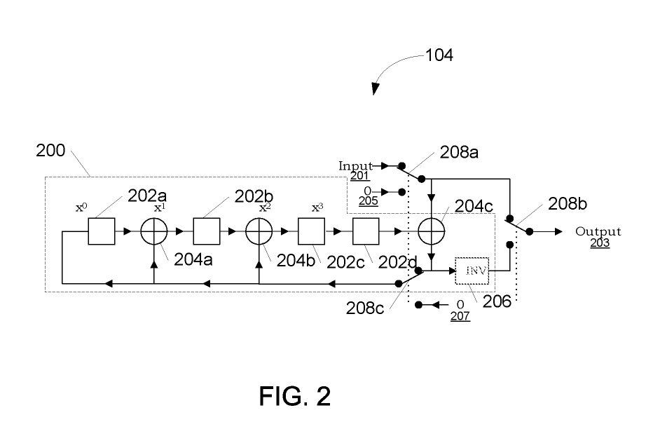

FIG. 2 is a diagram illustrating an example implementation of CRC block 104 in accordance with one embodiment. As can be seen, the CRC block implementation of FIG. 2 comprises an input 201 at which the input bits (b) are received and an output 203 at which the output bits (k) are presented. The CRC block implementation of FIG. 2 further comprises 3 switches 208a, 208b, and 208c, which are in the up position while the information bits (b) are being received. Thus, the input bits (b) will simply be passed from input 201 to output 203.

In order to add the CRC bits, switches 208a, 208b, and 208c are moved to the down position, connecting inputs 205 and 207 with the encoder section 200. In this example, inputs 205 and 207 are configured to feed “0's” to encoder section 200. Encoder section 200 comprises 4 one-bit storage registers 202a, 202b, 202c, and 202d, which are configured to store the input to each register 202 for one clock cycle and then shift the input out to the right, and 3 modulo-2 adders 204a, 204b, and 204c. The output of adder 204c is then input to inverter 206, which is configured to invert the output of adder 204c and pass the inverted result to output 203. In the example of FIG. 1, four inverted CRC bits (c) are added to the information bits (b).

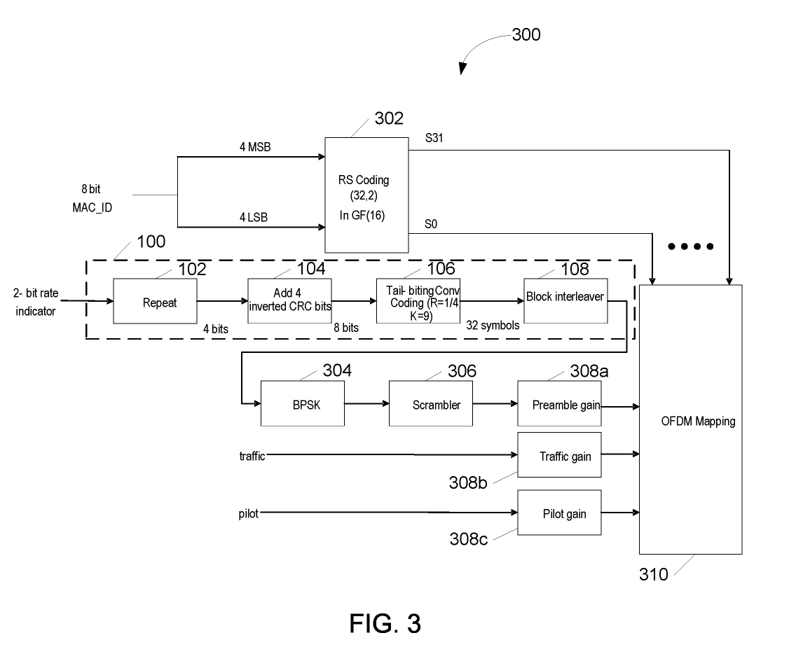

FIG. 3 is a diagram illustrating a portion of a transmitter 300 that includes encoder 100 for encoding the 2-bit rate indicator. In addition, transmitter 300 can also encode the, e.g., 8-bit MAC identifier onto the preamble channel. Transmitter 300 can also include encoders for other channels such as traffic channels and the pilot channel as well as other control channels. The encoders for these channels are not illustrated for simplicity.

The output of encoder 100 is input to BPSK block 304 where the output symbols are modulated and then scrambled in scrambling block 306. Scrambling randomizes the data bits, which can improve the peak-to-average power ratio for the transmitted signal. For example, if a long string of “1's” were to be transmitted, then the resulting peak-to-average power ratio would be high. By randomizing, or scrambling the data bits, the peak-to-average power ratio can be reduced.

The output of scrambling block 306 can then be passed to gain block 308a and then to OFDM mapping block 310 where the encoded and modulated rate indicator bits are mapped to the tiles assigned to the preamble channel. At the same time, the MAC identifier bits can undergo Reed-Solomon (RS) encoding in RS coding block 302. Reed-Solomon error correction is an error-correcting code that works by oversampling a polynomial constructed from the input bits. The polynomial is evaluated at several points, and these values are sent or recorded. By sampling the polynomial more often than is necessary, the polynomial is over-determined. As long as “many” of the points are received correctly, the receiver can recover the original polynomial even in the presence of a “few” bad points. Thus, in one embodiment, the 8-bit MAC identifier can be encoded into a 32 bit code. The encoded MAC identifier bits can then be mapped to the appropriate tones along with the encoded rate indicator bits.

In certain embodiments, the tile assignments provided in the 3GPP2 standard C30-20060731-046 can be used for the preamble channel. Thus, OFDM mapping block 310 can be configured to map the encoded rate indicator and MAC identifier bits to tiles assigned in accordance with the C30-20060731-046 standard.

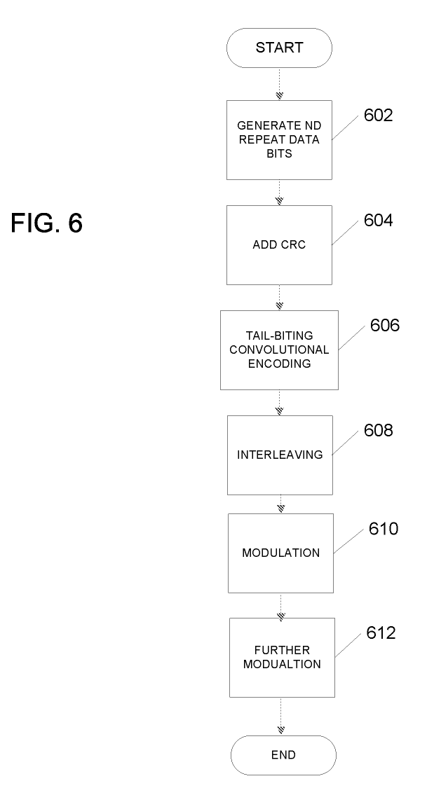

FIG. 6 is a flow chart illustrating an example method for encoding a preamble channel in accordance with one embodiment of the systems and methods described herein. First, in step 602, the data bits (b) are generated and repeated. In step 604 CRC bits (c) can be generated from, and added to the data bits (b). In step 606, the resulting input symbols can be encoding using a tail-biting convolutional encoding process to generate output symbols. In certain embodiments, the output symbols can be interleaved in step 608.

The output can then be modulated, e.g., using BPSK, QPSK, QAM, etc., in step 610. Finally, the modulated output can then be further modulated for transmission, e.g., using CDMA or OFDM, in step 612.

As noted, the transmitter of FIG. 3 can be included in a base station, or an access point for communicating the preamble channel to wireless communication devices with which it is in communication. It should also be noted that for best performance, the diversity, e.g., in time and/or frequency should be maximized.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

What is claimed:

1. An Orthogonal Frequency Division Modulation (OFDM) transmitter of a preamble channel, comprising:
an encoder configured to encode information bits onto the preamble channel, the encoder comprising:
a cyclical redundancy check (CRC) encoding block configured to receive the information bits, generate CRC bits, and add the CRC bits to the information bits forming input symbols;
a tail-biting convolutional encoder coupled with the CRC encoding block, the tail-biting convolutional encoder configured to generate output symbols from the input symbols using a tail biting technique; and
an interleaving block coupled with the tail-biting convolutional encoder, the interleaving block configured to interleave the output symbols;
a modulation block configured to modulate the interleaved output symbols and generate modulated output symbols;
a medium access control (MAC) identifier encoder configured to encode MAC identifier data; and
a tone mapping block configured to map the modulated output symbols and the encoded MAC identifier data onto tones assigned to the preamble channel.

2. The transmitter of claim 1, wherein the modulation block modulates the output symbols using one of the following modulations:
Binary-Phase Shift Keying (BPSK);
Quadrature Phase Shift Keying (QPSK); and
Quadrature Amplitude Modulation (QAM).

3. The transmitter of claim 1, further comprising a scrambling block coupled to the modulation block, the scrambling block configured to scramble the modulated output symbols using a scrambling code.

4. The transmitter of claim 3, further comprising gain block coupled with the scrambling block, the gain block configured to add gain to the scrambled output symbols.

5. The transmitter of claim 1, wherein the medium access control (MAC) identifier encoder is a Reed-Solomon encoder.

6. The transmitter of claim 1, wherein the (CRC) encoding block is further configured to invert the CRC bits before adding them to the information bits.

7. The transmitter of claim 1, wherein the information bits comprising rate indicator bits.

8. The transmitter of claim 1, further comprising a repetition block configured to repeat the information bits.

9. A method for encoding information bits onto a preamble channel, comprising:
generating CRC bits from the information bits;
adding the CRC bits to the information bits forming input symbols;
generating output symbols from the input symbols using a tail biting convolutional technique;
interleaving the output symbols;
modulating the interleaved output symbols;
encoding MAC identifier bits; and
mapping the modulated output symbols and encoded MAC identifier bits onto OFDM tones assigned to the preamble channel.

10. The method of claim 9, wherein the modulating the output symbols comprises modulating the output symbols using of the followings:
BPSK;
QPSK; and
QAM.

11. The method of claim 9, wherein encoding the MAC identifier bits comprise using Reed-Solomon coding to encode the MAC identifier bits.

12. An access point, comprising:
a receiver configured to receive coded signals; and
an Orthogonal Frequency Division Modulation (OFDM) transmitter configured to generate coded signals of a preamble channel for transmission, the transmitter comprising:
a channel encoder configured to encode information bits, the channel encoder comprising:
a cyclical redundancy check (CRC) encoding block configured to receive the information bits, generate CRC bits, and add the CRC bits to the information bits forming input symbols;
a tail-biting convolutional encoder coupled with the CRC encoding block, the tail-biting convolutional encoder configured to generate output symbols from the input symbols using a tail biting technique; and
an interleaving block coupled with the tail-biting convolutional encoder, interleaving block configured to interleave the output symbols;
a modulation block configured to modulate the interleaved output symbols and generate modulated output symbols;
a medium access control (MAC) identifier encoder configured to encode MAC identifier data; and
a tone mapping block configured to map the modulated output symbols and the encoded MAC identifier data onto tones assigned to the preamble channel.

13. The access point of claim 12, wherein the modulation block modulates the output symbols using one of the followings:
Binary-Phase Shift Keying (BPSK);
Quadrature Phase Shift Keying (QPSK); and
Quadrature Amplitude Modulation (QAM).

14. The access point of claim 12, wherein the transmitter further comprises a scrambling block coupled to the modulation block, the scrambling block configured to scramble the modulated output symbols using a scrambling code.

15. The access point of claim 14, wherein the transmitter further comprises a gain block coupled with the scrambling block, the gain block configured to add gain to the scrambled output symbols.

16. The access point of claim 12, wherein the medium access control (MAC) identifier encoder is a Reed-Solomon encoder.

17. The access point of claim 12, wherein the (CRC) encoding block is further configured to invert the CRC bits before adding them to the information bits.

18. The access point of claim 12, wherein the transmitter further comprises a repetition block configured to repeat the information bits.

19. An encoder for encoding information bits, comprising:
a repetition block configured to repeat the information bits;
a cyclical redundancy check (CRC) encoding block configured to receive the repeated information bits, generate CRC bits, and add the CRC bits to the information bits forming input symbols;
a tail-biting convolutional encoder coupled with the CRC encoding block, the tail-biting convolutional encoder configured to generate output symbols from the input symbols using a tail biting technique; and
an interleaving block coupled with the tail-biting convolutional encoder, interleaving block configured to interleave the output symbols.

20. The encoder of claim 19, wherein the CRC encoding block comprises:
an input configured to receive the repeated information bits;
an output configured to output the input symbols;
an encoding block, the encoding block configured to generate the CRC bits, the encoding block comprising at least one 1 bit storage register and at least one modulo-2 adder; and
a switching network coupled between the input and the output and between the encoder and the output, the switching network configured to switchably connect the input and the encoder with the output.
